(19) United States
(12) Patent Application Publication
(10) Pub. No.: US 2012/0249600 A1
(43) Pub. Date: Oct. 4, 2012

(54) INFORMATION PROCESSING APPARATUS AND METHOD

(75) Inventors: Shuji MIYAMOTO, Tokyo (JP); Shunichi Saito, Tokyo (JP)

(73) Assignee: KABUSHIKI KAISHA TOSHIBA, Tokyo (JP)

(21) Appl. No.: 13/280,721

(22) Filed: Oct. 25, 2011

(30) Foreign Application Priority Data
Mar. 31, 2011 (JP) 2011-078559

(51) Int. Cl. G09G 5/00

(52) U.S. Cl. 345/672

(57) ABSTRACT

In one embodiment, the information processing apparatus includes an acceleration sensor configured to detect acceleration of the information processing apparatus, and a display part configured to include a screen for displaying an image. The apparatus further includes a determination part configured to determine whether a displayed position of the image is to be corrected, based on duration of a state in which the acceleration occurs in a predetermined direction. The apparatus further includes a correction part configured to correct the displayed position of the image according to the determination made by the determination part.

### CROSS REFERENCE TO RELATED APPLICATION

This application is based upon and claims the benefit of priority from the prior Japanese Patent Application No. 2011-78559, filed on Mar. 31, 2011, the entire contents of which are incorporated herein by reference.

### FIELD

Embodiments described herein relate to an information processing apparatus and method.

### BACKGROUND

A user often views a display of an information terminal such as a mobile phone or smartphone while walking. Therefore, due to a shake of the user or the terminal, the user may have difficulty of viewing the display.

Therefore, there is known a method in which the shake of the terminal is detected by an acceleration sensor, and a position of the user's face is identified through analysis of a camera image, to correct a displayed position of an image on the display according to a relative shake of the terminal with respect to the position of the face.

In this method, however, continuous analysis of the camera image increases power consumption of the terminal, resulting in a reduction in usable time of the terminal. In addition, in this method, a provision of means of identifying the position of the face on the terminal increases a fabrication cost of the terminal.

### BRIEF DESCRIPTION OF THE DRAWINGS

FIG. 1 is a schematic diagram showing a configuration of an information terminal of a first embodiment;

FIG. 2 is a perspective view showing an external appearance of the information terminal of the first embodiment;

FIG. 3 is a flowchart for describing a method of correcting a displayed position in the first embodiment;

FIGS. 4A and 4B are diagrams for describing shakes of a user's head and the information terminal;

FIGS. 5A and 5B are graphs showing movement of the user's head and the information terminal upon walking;

FIGS. 6A and 6B are graphs showing examples of a change of acceleration of the information terminal;

FIGS. 7A and 7B are diagrams for describing a correction amount of the displayed position;

FIG. 8 is a graph showing an example of a method of determining the correction amount of the displayed position;

FIG. 9 is a graph showing a change of the correction amount of the displayed position in the case of FIG. 8;

FIG. 10 is a graph showing a relationship between an inclination of the information terminal and the correction amount of the displayed position;

FIG. 11 is a graph showing changes in positions of the information terminal and the user's head;

FIGS. 12A and 12B are graphs for describing a method of estimating the change in position of the user's head;

FIGS. 13A and 13B are graphs showing the change of the correction amount of the displayed position in the case of FIG. 8 and the case of the second embodiment; and

FIG. 14 is a block diagram showing a configuration of the information terminal of the second embodiment.

### DETAILED DESCRIPTION

Embodiments will now be explained with reference to the accompanying drawings.

An embodiment described herein is an information processing apparatus including an acceleration sensor configured to detect acceleration of the information processing apparatus, and a display part configured to include a screen for displaying an image. The apparatus further includes a determination part configured to determine whether a displayed position of the image is to be corrected, based on duration of a state in which the acceleration occurs in a predetermined direction. The apparatus further includes a correction part configured to correct the displayed position of the image according to the determination made by the determination part.

Another embodiment described herein is an information processing method including displaying an image on a screen of an information processing apparatus, and detecting acceleration of the information processing apparatus. The method further includes determining whether a displayed position of the image is to be corrected, based on duration of a state in which the acceleration occurs in a predetermined direction. The method further includes correcting the displayed position of the image according to the determination.

### First Embodiment

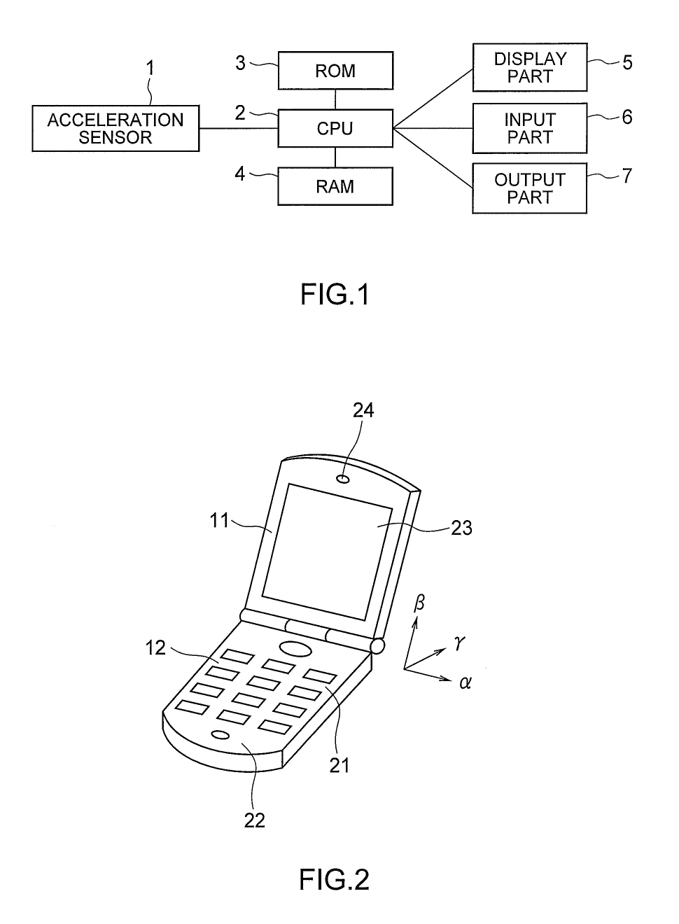

FIG. 1 is a schematic diagram showing a configuration of an information terminal of a first embodiment. The information terminal in FIG. 1 is an example of an information processing apparatus of the disclosure. Examples of the information terminal in FIG. 1 include portable information terminals such as a mobile phone and a smartphone.

The information terminal in FIG. 1 includes an acceleration sensor 1 that detects accelerations of the information terminal, and a CPU 2 that performs various information processing. The accelerations detected by the acceleration sensor 1 are output to the CPU 2.

In addition, the information terminal in FIG. 1 includes a ROM 3 storing various programs and data, and a RAM 4 which is used as a memory of the CPU 2. Furthermore, the information terminal in FIG. 1 includes a display part 5, an input part 6, and an output part 7, as a user interface.

FIG. 2 is a perspective view showing an external appearance of the information terminal of the first embodiment.

As shown in FIG. 2, the information terminal of the present embodiment is a flip mobile phone and includes a cover part 11 and a main body part 12. The main body part 12 is provided with operating buttons 21 and a microphone 22 which are examples of the input part 6. The cover part 11 is provided with a screen 23 composing the display part 5, and a speaker 24 which is an example of the output part 7.

Arrows α and β shown in FIG. 2 indicate directions parallel to the screen 23. Specifically, the arrows α and β respectively indicate the horizontal direction and up and down direction of the screen 23. In addition, an arrow γ shown in FIG. 2 indicates a direction perpendicular to the screen 23. The above-described acceleration sensor 1 is configured to detect accelerations in the α, β and γ directions of the information terminal.

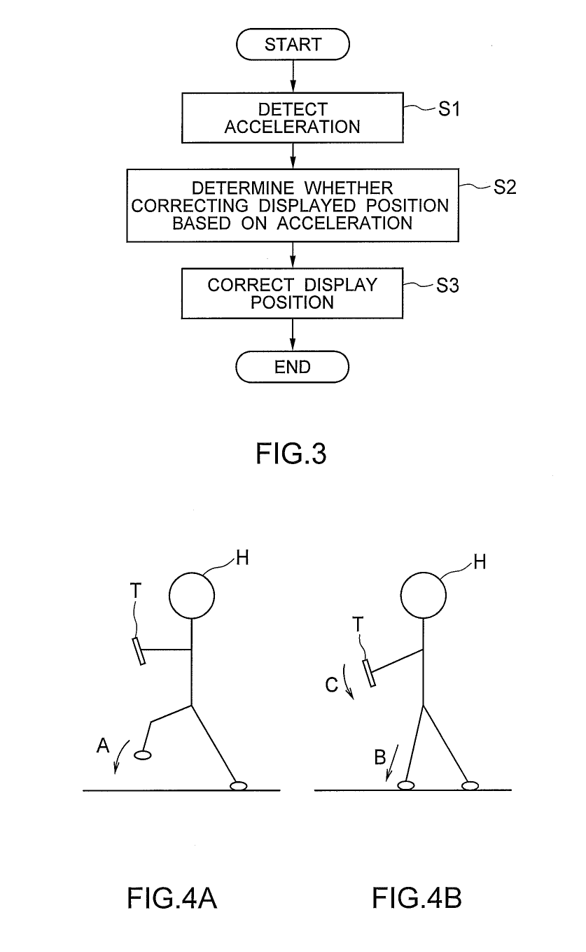

FIG. 3 is a flowchart for describing a method of correcting a displayed position in the first embodiment.

When the power to the information terminal of the present embodiment is turned on, the information terminal displays an image on the screen 23, and starts detection of accelerations by the acceleration sensor 1 (step S1). Specifically, the acceleration sensor 1 detects the accelerations of the information terminal in the α, β and γ directions. The detection of the accelerations by the acceleration sensor 1 is continuously performed. The accelerations detected by the acceleration sensor 1 are output to the CPU 2 as electrical signals.

Then, the CPU 2 checks an acceleration state of the information terminal from the electrical signals. Specifically, the CPU 2 checks whether upward acceleration continuously occurs. As will be described later, it is possible to estimate, from such upward acceleration, whether the information terminal is shaking relative to a user's head.

When the upward acceleration continuously occurs, it is estimated that the information terminal is shaking relative to the user's head. Therefore, in this case, the CPU 2 determines to correct the displayed position of the image on the screen 23 (step S2). Then, the CPU 2 corrects the displayed position of the image on the screen 23 (step S3). At this time, the displayed position of the image is corrected in an opposite direction of that of the shake so as to cancel out the relative shake.

On the other hand, when the upward acceleration does not continuously occur, it is estimated that the shake of the information terminal is synchronized with the shake of the user's head. Therefore, in this case, the CPU 2 determines not to correct the displayed position of the image on the screen 23 (step S2).

Note that the functions of performing steps S2 and S3 are implemented by performing a program on the CPU 2. The functions of performing steps S2 and S3 are examples of a determination part and a correction part of the disclosure, respectively.

(1) Details of Steps S2 and S3

Next, the details of the processes at steps S2 and S3 will be described with reference to FIGS. 4A to 6B.

FIGS. 4A and 4B are diagrams for describing the shakes of the user's head and the information terminal.

In FIG. 4A, reference character T represents the information terminal of the present embodiment, and reference character H represents the user's head. FIG. 4A shows a state in which the user is walking while viewing the screen of the information terminal T.

In general, the movement of the head H and the movement of the information terminal T are not completely synchronized with each other and subtly differ from each other. The difference in movement between the head H and the information terminal T increases when a user's foot lands.

An arrow “A” in FIG. 4A indicates a state in which the user's foot is about to land. An arrow “B” in FIG. 4B indicates a state in which the user's foot has landed. At this time, as indicated by an arrow “C”, the information terminal T sinks downward due to its inertia. By this, the difference in movement between the head H and the information terminal T increases. The difference in movement between the head H and the information terminal T corresponds to a relative shake between the head H and the information terminal T.

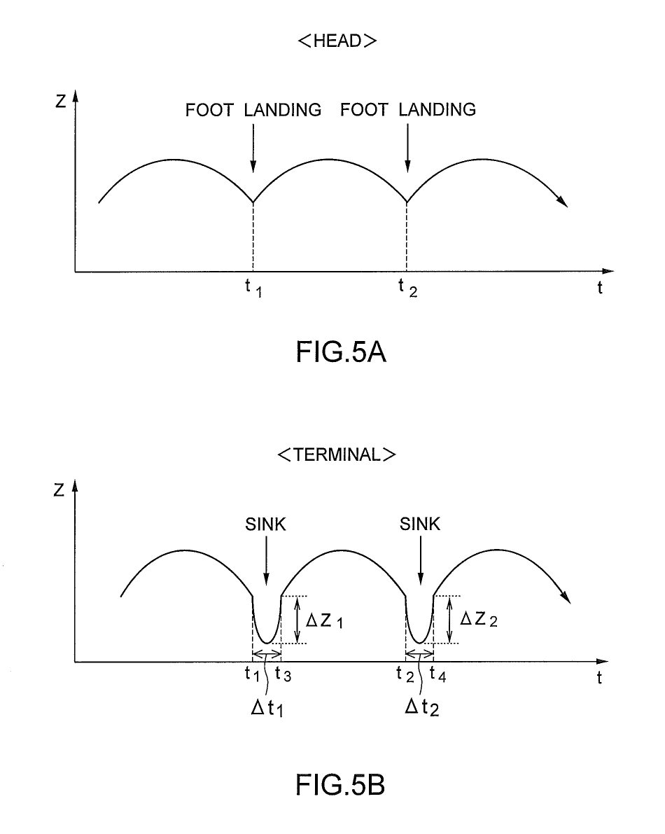

FIGS. 5A and 5B are graphs showing the movement of the user's head and the information terminal upon walking. The horizontal axis t in FIGS. 5A and 5B represents time. The vertical axis Z in FIGS. 5A and 5B represents the coordinate in a height direction, i.e., the coordinate opposite to a direction in which gravity acts.

FIG. 5A shows the movement of the head upon walking. In general, as shown in FIG. 5A, the movement of the head upon walking is such that ups and downs are repeated in a certain rhythm. In addition, the position of the head upon walking is lowest at the timing at which the foot lands.

On the other hand, FIG. 5B shows the movement of the information terminal upon walking. When the user is walking while viewing the screen of the information terminal, the movement of the information terminal is roughly synchronized with the movement of the user's head (FIG. 5B). However, when the user's foot lands, the movement of the information terminal is a downward sinking movement due to its inertia.

In FIGS. 5A and 5B, the timings at which the foot lands are represented by t₁ and t₂. In addition, FIG. 5B shows a state in which the sinking of the information terminal occurs during time Δt₁(=t₃−t₁) due to the landing of the foot at t₁, and a state in which the sinking of the information terminal occurs during time Δt₂(=t₄−t₂) due to the landing of the foot at t₂. In addition, in FIG. 5B, the amount of sinking due to the landing at t₁ is represented by ΔZ₁ and the amount of sinking due to the landing at t₂ is represented by AΔ₂.

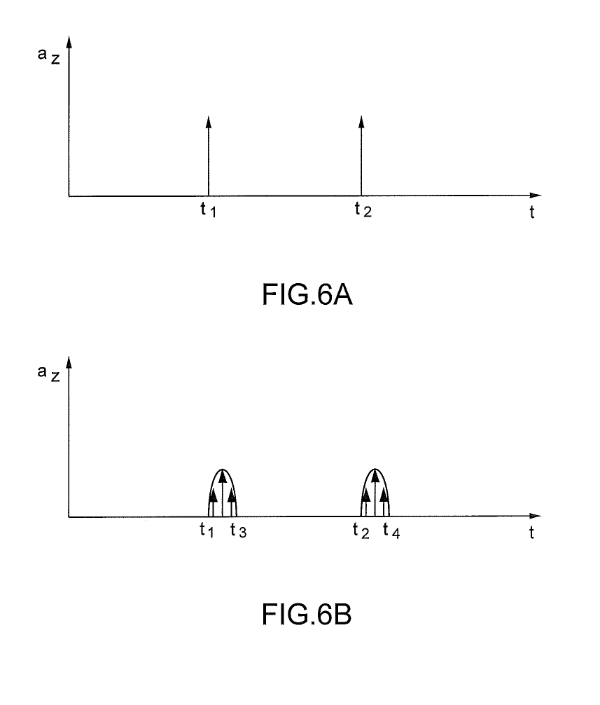

In general, the sinking times Δt₁ and Δt₂ and the amounts of sinking ΔZ₁ and ΔZ₂ change according to the weight of the information terminal. When the information terminal is light, the sinking time is short and the amount of sinking is small, and accordingly, the movement of the information terminal is a movement substantially synchronized with the movement of the head. On the other hand, when the information terminal is heavy, the sinking time is long and the amount of sinking is large, and accordingly, sinking of the information terminal at landing is remarkable. The difference between the above-described two cases will be described with reference to FIGS. 6A and 6B.

FIGS. 6A and 6B are graphs showing examples of the change of the acceleration of the information terminal. The horizontal axis t in FIGS. 6A and 6B represents time. The vertical axis a_{z} in FIGS. 6A and 6B represents the acceleration in a Z direction of the information terminal. Namely, a_{z} represents the upward acceleration of the information terminal. The Z direction is an example of a predetermined direction of the disclosure.

The acceleration of the information terminal upon walking is downward acceleration which is close to the gravitational acceleration at free fall. However, the acceleration of the information terminal upon walking turns into upward acceleration when the user's foot lands (see FIGS. 6A and 6B). This results from the fact that an upward force against the sinking of the information terminal acts on the information terminal through a user's hand.

However, the value and duration of the upward acceleration at landing change according to the weight of the information terminal. FIG. 6A shows the change of the upward acceleration a_{z} when the information terminal is light, and FIG. 6B shows the change of the upward acceleration a_{z} when the information terminal is heavy.

The reason that such a difference is observed in the upward acceleration a_{z} according to the weight of the information terminal will be described below.

When the user's foot lands, velocity of the information terminal changes from downward velocity to upward velocity due to a force acting on the information terminal through the user's hand.

At this time, when the information terminal is light, by applying a force only for a moment, the velocity of the information terminal changes from the downward velocity to the upward velocity. Therefore, when the information terminal is light, momentary high acceleration occurs as the upward acceleration a_{z} at landing (FIG. 6A). As a result, there is almost no sinking of the information terminal and accordingly the movement of the information terminal is a movement substantially synchronized with the movement of the head.

On the other hand, when the information terminal is heavy, the velocity of the information terminal does not change from the downward velocity to the upward velocity unless a force is continuously applied. Therefore, when the information terminal is heavy, continuous low acceleration occurs as the upward acceleration a_{z} at landing (FIG. 6B). As a result, the sinking of the information terminal continues until the displacement of the information terminal catches up with the displacement of the user's whole body.

Accordingly, a relative shake between the user's head and the information terminal can be estimated from the upward acceleration a_{z} of the information terminal. When momentary acceleration occurs as the acceleration a_{z}, it is estimated that the shake of the information terminal is synchronized with the shake of the head. On the other hand, when continuous acceleration occurs as the acceleration a_{z}, it is estimated that a relative shake between the user's head and the information terminal occurs.

Therefore, when the CPU 2 obtains the accelerations in the α, β and γ directions from the acceleration sensor 1, the CPU 2 calculates the acceleration in the Z direction (i.e., upward acceleration) a_{z} from these accelerations. Then, the CPU 2 checks whether the upward acceleration a_{z} occurs continuously. The CPU 2 then determines whether the displayed position of the image on the screen 23 is to be corrected, based on the duration of a state in which the upward acceleration a_{z} occurs (step S2: FIG. 3).

For example, when the above-described duration is greater than or equal to a threshold value, the CPU 2 determines to correct the displayed position of the image (step S2). Then, the CPU 2 corrects the displayed position of the image on the screen 23 (step S3). At this time, the displayed position of the image is corrected in a direction opposite to the direction of the shake so as to cancel out the relative shake between the user's head and the information terminal.

On the other hand, when the above-described duration is less than the threshold value, the CPU 2 determines not to correct the displayed position of the image (step S2).

As described above, in the present embodiment, a determination as to whether to correct the displayed position of the image on the screen 23 is made based on the duration of a state in which the upward acceleration a_{z} occurs. Therefore, in the present embodiment, the correction of the displayed position against the shake can be made based on the results of detection of the accelerations by the acceleration sensor 1, without through analysis of a camera image and the like. Therefore, according to the present embodiment, the correction of the displayed position against the shake can be made while suppressing an increase in the power consumption of the information terminal.

Note that a relationship between the timing at which the above-described duration is detected and the timing at which this detection result is reflected in correction may be set in any manner.

For example, the duration during which a single sinking continues (Δt₁ or Δt₂) may be detected, and when the duration is greater than or equal to a threshold value, the displayed position may be corrected at next sinking. This is effective, for example, for the case in which there are a few variations in sinking time or the amount of sinking at each sinking.

Alternatively, the upward acceleration a_{z} may be analyzed every fixed cycle, and when a state in which the upward acceleration a_{z} occurs continues during a single cycle, the displayed position may be corrected in the next cycle. This is effective, for example, for the case in which there are many variations in sinking time or the amount of sinking at each sinking.

(2) Correction Amount of Displayed Position

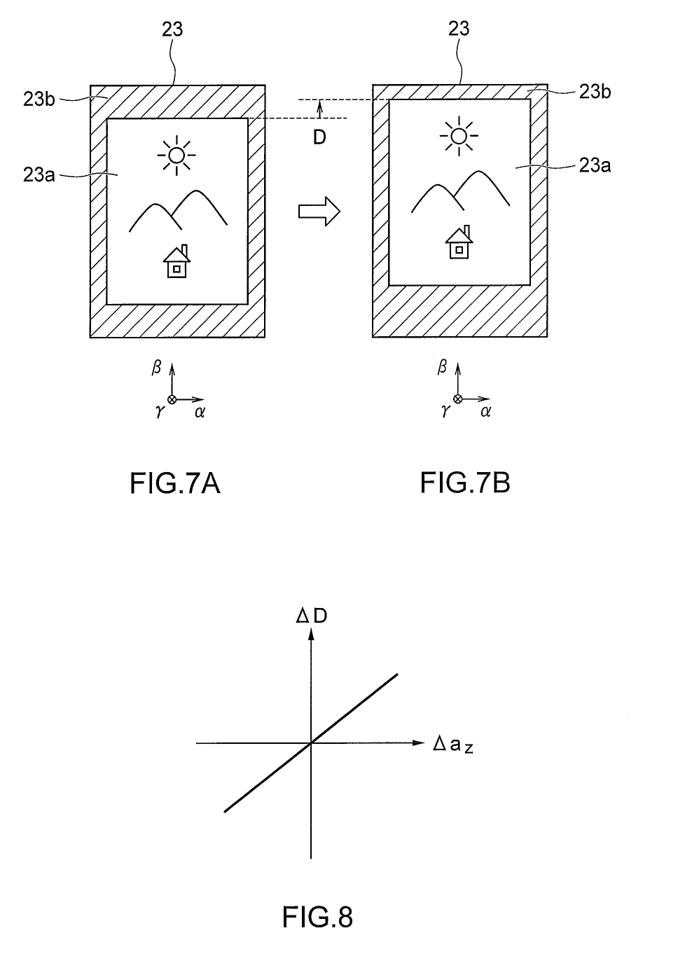

Next, the correction amount of the displayed position will be described with reference to FIGS. 7A to 10.

FIGS. 7A and 7B are diagrams for describing the correction amount of the displayed position.

FIG. 7A shows a state in which the screen 23 is viewed from the front. The screen 23 includes an image display region 23a where an image to be displayed is displayed, and a black display region 23b where a black surrounding that surrounds the image is displayed.

In the present embodiment, when it is determined to correct the displayed position of the image, as shown in FIG. 7B, the displayed position of the image is corrected in a +β direction. Namely, the displayed position of the image is corrected in an upward direction of the screen 23. In this manner, the displayed position of the image is corrected in a direction opposite to the direction of the relative shake between the user's head and the information terminal.

Reference character D shown in FIG. 7B represents the correction amount of the displayed position of the image. FIG. 7B shows a state in which the displayed position of the image is corrected by the distance D in the +β direction. In the present embodiment, the correction amount D of the displayed position is determined based on the value of the upward acceleration a_{z}.

A method of determining the correction amount D of the displayed position will be described below with reference to FIGS. 8 to 10.

FIG. 8 is a graph showing an example of the method of determining the correction amount D of the displayed position. The horizontal axis Δa_{z} in FIG. 8 represents an increment of the acceleration a_{z} during a fixed period of time. The vertical axis ΔD in FIG. 8 represents an increment of the correction amount D.

In FIG. 8, when the acceleration a_{z} increases during the fixed period of time (Δa_{z}>0), the correction amount D is then increased immediately (ΔD>0). Specifically, when the acceleration a_{z} increases, the correction amount D is increased to D+ΔD, and the displayed position of the image is moved in the +β direction.

On the other hand, when the acceleration a_{z} decreases during a fixed period of time (Δa_{z}<0), the correction amount D is then reduced immediately (ΔD<0). Specifically, when the acceleration a_{z} decreases, the correction amount D is reduced to D+ΔD, and the displayed position of the image is moved in a −β direction.

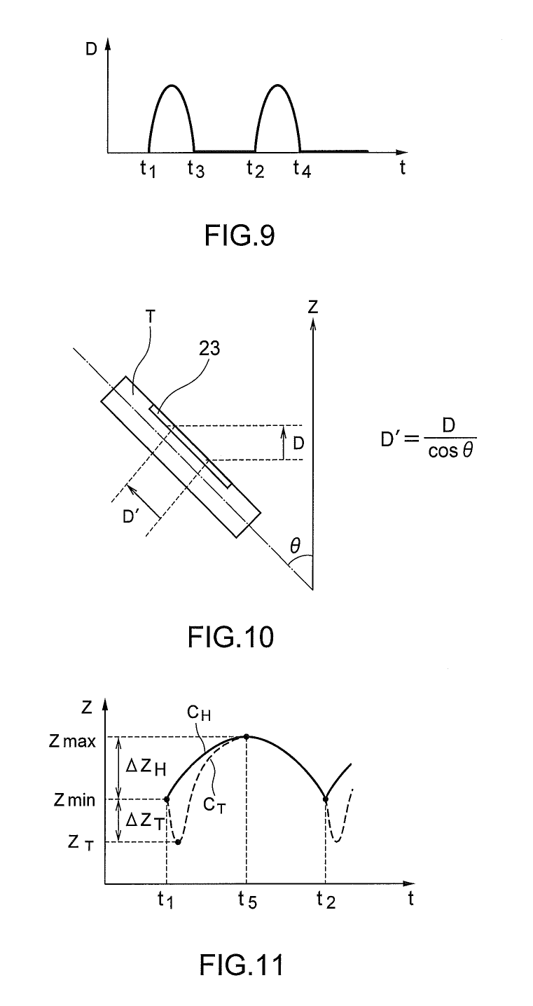

According to such displayed position correction, as shown in FIG. 9, the displayed position is corrected, synchronized with the occurrence of sinking. FIG. 9 is a graph showing the change of the correction amount D of the displayed position in the case of FIG. 8.

Note that although, in FIG. 8, AD is set to be proportional to the value of Δa_{z} the correction amount D may be determined in any other manner based on the value of the acceleration a_{z}. For example, the correction amount D may be determined based on a value obtained by integrating acceleration a, twice with respect to time t, i.e., the displacement in the Z direction of the information terminal. In this case, since the correction amount D is determined according to the magnitude of sinking at each time t, displayed position correction with high accuracy can be implemented.

Alternatively, the correction amount D may be determined based on the value of sinking time (Δt₁ or Δt₂). For example, the correction amount D is set to a larger value as the sinking time increases. This is effective, for example, for the case in which a determination as to whether to correct the displayed position is made based on the sinking time.

Alternatively, the correction amount D may be changed according to an inclination of the information terminal. Such displayed position correction will be described below with reference to FIG. 10.

FIG. 10 is a graph showing a relationship between the inclination of the information terminal and the correction amount of the displayed position.

FIG. 10 shows a state in which the screen 23 of the information terminal T is inclined at an angle θ relative to a Z direction. Reference character D represents the correction amount for the case of θ=0°, and reference character D′ represents the correction amount for the case of θ≠0°.

In FIG. 10, the correction amount D is determined by any of the above-described methods (e.g., the method shown in FIG. 8) and the correction amount D′ is determined such that D′=D/cos θ. Therefore, in FIG. 10, the correction amount of the displayed position increases according to an increase in the inclination of the information terminal T. Therefore, the displayed position correction with high accuracy which takes into account the inclination of the information terminal T can be implemented.

Note that although, in FIG. 10, the displayed position correction is performed based on the inclination angle θ of the information terminal T relative to the Z direction, the displayed position correction may be performed based on the inclination angle of the information terminal T relative to other directions, e.g., the inclination angle relative to a horizontal direction. When this angle is represented as φ, the above-described correction amount D′ is represented by D′=D/sin φ.

As described above, in the present embodiment, a determination as to whether to correct the displayed position of the image on the screen 23 is made based on the duration of a state in which the upward acceleration a_{z} occurs. Therefore, in the present embodiment, the correction of the displayed position against the shake can be made based on the results of detection of the accelerations by the acceleration sensor 1, without through analysis of a camera image and the like. Therefore, according to the present embodiment, the correction of the displayed position against the shake can be made while suppressing an increase in the power consumption of the information terminal.

A second embodiment which is a modification of the first embodiment will be described below mainly on differences from the first embodiment.

### Second Embodiment

FIG. 11 is a graph showing the changes in positions of the information terminal and the user's head.

A curve C_{T} shown in FIG. 11 represents the change in position of the information terminal in the Z direction. In the present embodiment, the case is assumed in which the information terminal is so heavy that the amount of sinking ΔZ_{T} of the information terminal is large, as indicated by the curve C_{T}. Furthermore, it is assumed that the information terminal is so heavy that the sinking of the information terminal continues over a long period of time, as indicated by the curve C_{T}. Note that the change in position of the information terminal in the Z direction can be calculated by integrating the upward acceleration a_{z} twice with respect to time t.

On the other hand, a curve C_{H} represents the change in position of the user's head in the Z direction. The change in position of the head in the Z direction can be estimated from the change in position of the information terminal in the Z direction. A method of estimating the change in position of the head and a method of using a result of the estimation will be described below with reference to FIGS. 11 to 14.

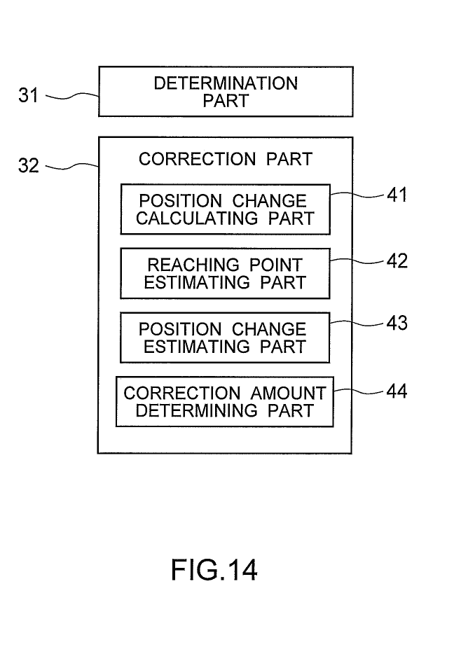

In the present embodiment, by a configuration shown in FIG. 14, the CPU 2 calculates the change in position of the information terminal, estimates the change in position of the head, and then determines the correction amount of the displayed position of the image, based on a result of the calculation of the change in position of the information terminal and a result of the estimation of the change in position of the head.

FIG. 14 is a block diagram showing a configuration of the information terminal of the second embodiment.

In the present embodiment, the configuration shown in FIG. 14 is implemented by executing a program on the CPU 2. A determination part 31 is a block that performs a process of the step S2 (see FIG. 3), and a correction part 32 is a block that performs a process of the step S3. The correction part 32 includes a position change calculating part 41, a reaching point estimating part 42, a position change estimating part 43, and a correction amount determining part 44.

A method of estimating the change in position of the head and a method of using a result of the estimation which are performed by the blocks 41 to 44 will be described below.

When estimating the change in position of the head at given sinking, the reaching point estimating part 42 estimates the maximum reaching point Zmax and minimum reaching point Zmin of the change in position of the head (see FIG. 11) from a calculation result of the change in position of the information terminal at the last sinking. As the calculation result of the change in position of the information terminal, a result obtained by the calculation using the acceleration a, by the position change calculating part 41 is used.

Specifically, the reaching point estimating part 42 estimates the reaching time of the maximum reaching point Zmax, the reaching time of the minimum reaching point Zmin, and a difference in Z-coordinate between the maximum reaching point Zmax and the minimum reaching point Zmin.

The reaching time of the minimum reaching point Zmin can be estimated as the start time t₁ of the sinking of the information terminal (FIG. 11). The reaching time of the maximum reaching point Zmax can be estimated as the time t₅ at which the change in position of the information terminal reaches its maximum reaching point (FIG. 11). The difference in Z-coordinate between the maximum reaching point Zmax and the minimum reaching point Zmin can be estimated to match the displacement of the information terminal in the Z direction between the time t₁ and the time t₅.

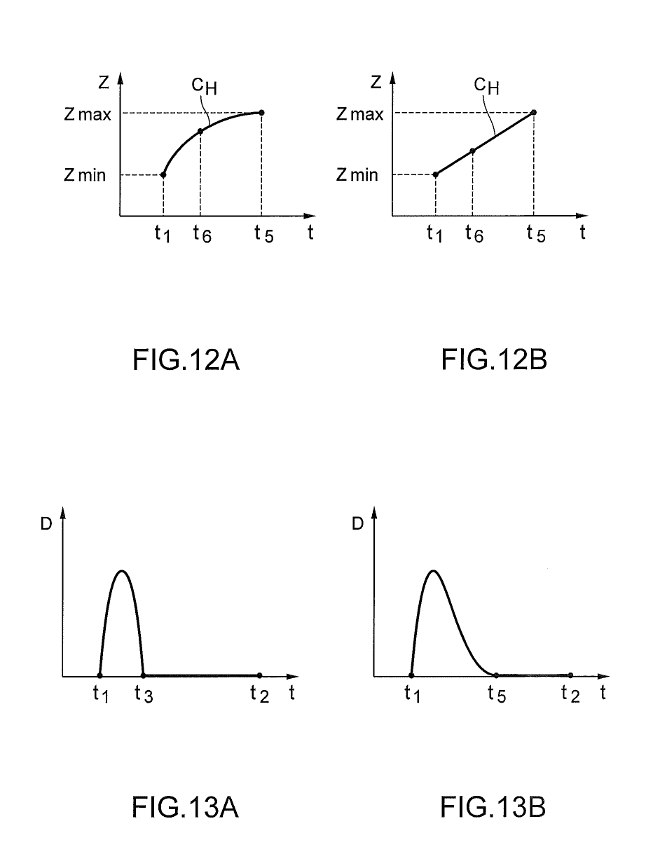

The position change estimating part 43 then estimates the change in position of the head, based on the maximum reaching point Zmax and the minimum reaching point Zmin. As shown in FIGS. 12A and 12B, the change in position of the head can be estimated by an interpolation process using the maximum reaching point Zmax and the minimum reaching point Zmin, for example.

FIGS. 12A and 12B are graphs for describing a method of estimating the change in position of the user's head.

FIG. 12A shows an example in which the change in position of the head C_{H} is interpolated by a parabolic line between Zmin and Zmax. FIG. 12B shows an example in which the change in position of the head C_{H} is interpolated by a straight line between Zmin and Zmax. According to these interpolation processes, the position of the head at arbitrary time t₆ can be estimated between the time t₁ and the time t₅.

The interpolation process may be performed using other curves than the parabolic line and the straight line. The change in position of the head may be estimated by a comparison process with actual measurement data, instead of the interpolation process. The estimation by the comparison process can be implemented, for example, by preparing a plurality of samples of actual measurement data of the change in position of the head, selecting a sample closest to the maximum reaching point Zmax and the minimum reaching point Zmin estimated by the reaching point estimating part 42, and using the selected sample as a result of the estimation of the change in position of the head.

The correction amount determining part 44 then determines the correction amount of the displayed position of the image, based on the calculation result of the change in position of the information terminal and the estimation result of the change in position of the head. Specifically, the correction amount determining part 44 determines the correction amount of the displayed position, based on the difference between the change in position of the information terminal and the change in position of the head. Therefore, in the present embodiment, even when the amount of sinking ΔZ_{T} of the information terminal is large and accordingly the sinking of the information terminal continues over a long period of time, the displayed position correction with high accuracy can be performed.

FIGS. 13A and 13B are graphs showing the changes of the correction amount D of the displayed position in the case of FIG. 8 and the case of the second embodiment. The correction amount D in the case of FIG. 8 is shown in FIG. 13A, and the correction amount D in the case of the second embodiment is shown in FIG. 13B. According to the second embodiment, as shown in FIG. 13B, the displayed position correction in which the estimation result of the change in position of the head is incorporated can be implemented.

As described above, in the present embodiment, the change in position of the information terminal is calculated, the change in position of the head is estimated, and then the correction amount of the displayed position of the image is determined based on the result of the calculation of the change in position of the information terminal and the result of the estimation of the change in position of the head. Therefore, even when the amount of sinking ΔZ_{T} of the information terminal is large and accordingly the sinking of the information terminal continues over a long period of time, the displayed position correction with high accuracy can be performed.

While certain embodiments have been described, these embodiments have been presented by way of example only, and are not intended to limit the scope of the inventions. Indeed, the novel apparatuses and methods described herein may be embodied in a variety of other forms; furthermore, various omissions, substitutions and changes in the form of the apparatuses and methods described herein may be made without departing from the spirit of the inventions. The accompanying claims and their equivalents are intended to cover such forms or modifications as would fall within the scope and spirit of the inventions.

1. An information processing apparatus comprising:
an acceleration sensor configured to detect acceleration of the information processing apparatus;
a display module configured to include a screen for displaying an image;
a determination module configured to determine to correct a displayed position of the image when duration of a state in which the acceleration occurs in a predetermined direction is longer than a threshold; and
a correction module configured to correct the displayed position of the image according to the determination made by the determination module,
wherein
the predetermined direction is opposite to a direction in which gravity acts, and
the correction module is configured to determine a correction amount of the displayed position, based on a value of the acceleration in the predetermined direction, and configured to vary the correction amount, based on an inclination of the information processing apparatus.

2. (canceled)

3. The apparatus of claim 1, wherein
determination module is configured to determine not to correct the displayed position when the duration is shorter than the threshold.

4. (canceled)

5. The apparatus of claim 1, wherein
the correction module is configured to determine the correction amount, based on an increment of the acceleration during a fixed period.

6. The apparatus of claim 1, wherein
the correction module is configured to determine the correction amount, based on a value obtained by integrating the acceleration twice with respect to time.

7. (canceled)

8. The apparatus of claim 1, wherein
the correction module is configured to determine the correction amount, based on the duration.

9. The apparatus of claim 1, wherein the correction module comprises:
a position change calculating module configured to calculate a change in position of the information processing apparatus, based on a value of the acceleration in the predetermined direction;
a reaching point estimating module configured to estimate a maximum reaching point and a minimum reaching point of a change in position of a user of the information processing apparatus, based on a result of the calculation of the change in position of the information processing apparatus;
a position change estimating module configured to estimate the change in position of the user, based on the maximum reaching point and the minimum reaching point; and
a correction amount determining module configured to determine the correction amount of the displayed position, based on the result of the calculation of the change in position of the information processing apparatus and a result of the estimation of the change in position of the user.

10. The apparatus of claim 9, wherein
the position change estimating module is configured to estimate the change in position of the user by interpolation with the maximum reaching point and the minimum reaching point.

11. An information processing method comprising:
displaying an image on a screen of an information processing apparatus;
detecting acceleration of the information processing apparatus;
determining to correct a displayed position of the image when duration of a state in which the acceleration occurs in a predetermined direction is longer than a threshold; and
correcting the displayed position of the image according to the determination,
wherein
the predetermined direction is opposite to a direction in which gravity acts, and
the correction of the displayed position comprises determining a correction amount of the displayed position, based on a value of the acceleration in the predetermined direction, and varying the correction amount, based on an inclination of the information processing apparatus.

12. (canceled)

13. The method of claim 11, wherein the determination of the correction comprises:
determining not to correct the displayed position when the duration is shorter than the threshold.

14. (canceled)

15. The method of claim 11, wherein
the correction of the displayed position comprises determining the correction amount, based on an increment of the acceleration during a fixed period.

16. The method of claim 11, wherein
the correction of the displayed position comprises determining the correction amount, based on a value obtained by integrating the acceleration twice with respect to time.

17. (canceled)

18. The method of claim 11, wherein the correction of the displayed position comprises determining the correction amount, based on the duration.

19. The method of claim 11, wherein the correction of the displayed position comprises:
calculating a change in position of the information processing apparatus, based on a value of the acceleration in the predetermined direction;
estimating a maximum reaching point and a minimum reaching point of a change in position of a user of the information processing apparatus, based on a result of the calculation of the change in position of the information processing apparatus;
estimating the change in position of the user, based on the maximum reaching point and the minimum reaching point; and
determining the correction amount of the displayed position, based on the result of the calculation of the change in position of the information processing apparatus and a result of the estimation of the change in position of the user.

20. The method of claim 19, wherein
the correction of the displayed position comprises estimating the change in position of the user by interpolation with the maximum reaching point and the minimum reaching point.
